(19) United States
(12) Patent Application Publication
(10) Pub. No.: US 2004/0220820 A1
(43) Pub. Date: Nov. 4, 2004

(54) System and method for creating and managing real estate agreements

(76) Inventors: Edward Jonathan Brush, Columbia, MD (US); Dale Propst, Columbia, MD (US); Michael A. Caggiano, McLean, VA (US)

Correspondence Address: GRAY CARY WARE & FREIDENRICH LLP, 153 TOWNSEND, SUITE 800, SAN FRANCISCO, CA, 94107, US

(21) Appl. No.: 10/615,344

(22) Filed: Jul. 8, 2003

Related U.S. Application Data
(63) Continuation-in-part of application No. 10/426,812, filed on May 1, 2003.

(51) Int. Cl. G06F 17/60

(52) U.S. Cl. 705/1

(57) ABSTRACT

A method and system for creating and managing future real estate agreements. The present method and system facilitate payment of a referral fee to a real estate service provider, such as a developer or builder, based on a future real estate agreement. The system and method may be embodied in a computer system, e.g., Future Realty System 200. The Future Realty System 200 allows electronic records describing the future real estate agreements to be created and stored in a relational database, e.g., Future Realty Database 210. The Future Realty System 200 and Database 210 are adapted to receive and monitor information regarding proposed, pending and closed real estate transactions to determine when an obligation under a future real estate agreement becomes due.

### CROSS-REFERENCE TO RELATED APPLICATION

This application is a continuation-in-part of U.S. patent application Ser. No. 10/426,812, which is incorporated herein by reference.

### FIELD OF THE INVENTION

The present invention generally relates to real estate agreements and more particularly, to a system and method for creating and managing real estate agreements, including novel “future real estate agreements” described below.

### BACKGROUND OF THE INVENTION

In the world of real estate development, agreements are typically entered into that involve promises that are exchanged between parties resulting in present obligations. For example, in the sale of a home, a builder or developer transfers title to the home to a buyer in exchange for a certain amount of money, or a real estate broker may represent a buyer in the purchase of a home for a commission derived from a sale price. These conventional bilateral agreements generally involve a present property and/or service and do not contemplate other mutually beneficial business arrangements that could potentially occur in the future. Furthermore, these agreements generally involve two parties (e.g., a builder and buyer) and do not concern or involve other real estate service providers who are not party to the agreements. On average, most persons buying a home will likely sell the home they purchase within about six years and/or purchase a new home within that time. During the subsequent transaction (e.g., the subsequent sale and/or purchase), the buyer will likely require the services of a real estate provider, such as a real estate agent or broker, title company, mortgage broker and the like. However, conventional real estate contracts do not contemplate a buyer's need for future real estate services and do not include any provisions for securing the potential future business or referring the business to other providers. Due to the competitive nature of the real estate market, most real estate service providers (e.g., builders, developers, agents, brokers, lenders, mortgage brokers, insurers and the like) could benefit from a system in which incentives are provided to buyers in exchange for future business. Moreover, most real estate service providers would desire the opportunity to obtain a referral fee from a real estate broker in exchange for future business.

It would therefore be desirable to provide a method and system for creating “future real estate agreements” in which a buyer or client agrees to use a select real estate service provider for a future or contingent real estate transaction in exchange for a present financial incentive. It would further be desirable to provide a method and system for detecting when obligations under such future real estate agreements become due, for notifying affected parties, and for facilitating the payment of a referral fee to a real estate service provider, such as a developer or builder, once the proceeds from a satisfied obligation are collected.

### SUMMARY OF THE INVENTION

The present invention relates generally to a method and system for creating and managing real estate agreements, including future real estate agreements. The present method and system detect when obligations under future real estate agreements are about to become due or have already become due. They also facilitate payment of a referral fee to a real estate service provider, such as a developer or builder, agent, broker, lender, mortgage broker, insurer and the like, based on a future real estate agreement.

In accordance with the teachings of the present invention, a developer, builder or other real estate service provider offers a client a financial incentive in exchange for agreeing in writing to a future real estate agreement, such as an agreement to sell a home through a select real estate agent or broker.

A client may be a prospective purchaser of property. When the prospective purchaser is negotiating a purchase price with the developer or builder of the property, one of the items that are negotiated is the closing costs for the transaction. These closing costs may include title insurance fees, settlement agent charges, as well as numerous different kinds of taxes and fees. Some of these charges can be discounted and others, for example, taxes, cannot. Concerning those charges that can be discounted, during the course of negotiations to purchase the home, the developer or builder may offer the prospective purchaser a financial incentive in the form of, for example, either a discount on some of the closing costs or a discount on the purchase price of the home. The condition precedent to the developer or builder agreeing to discount those fees or prices is a written agreement by the prospective purchaser that the purchaser use a select real estate service provider for a future real estate transaction. For example, the agreement could be that should the prospective purchaser purchase the home, he or she will agree, when the time comes to sell the home, they will list the home with a real estate broker designated by a middleman and with whom the middleman has a relationship. Upon making the agreement, the developer or builder provides the agreed upon discount and when the purchase of the home is completed, provides the referral to either the middleman or to a selected real estate broker.

According to the method and system of the present invention, the builder, provider and/or middleman will receive and monitor information regarding proposed, pending and closed real estate transactions to determine when an obligation under a future real estate agreement is about to become due or has already become due. Preferably, this monitoring is facilitated by use of a computer system and relational database. When an obligation is fulfilled, an agreed-upon referral commission or fee may be paid to a middleman who takes a portion of the commission and pays the rest to the builder or provider.

In one embodiment, a middleman has entered into an agreement with the developer or builder to facilitate the intended transaction. The middleman may provide the developer or builder a preprinted agreement that can be signed by the prospective purchaser so that the agreement regarding a future real estate listing and/or buyer/broker agreement can be entered into. The middleman may provide a list of real estate agents and brokers from whom the prospective purchaser can choose a desired agent or broker, and ensure that all of the real estate agents and brokers listed have agreed to pay the referral fee required under the system. The middleman may also provide and manage a computer system and relational database for monitoring any and all transactions that might occur vis-à-vis homes that are subject to the future referral agreements. When such a home enters the Multiple Listing Service or some other marker indicates to the middleman that the home is up for sale, the middleman checks to ensure that the approved real estate agent or broker has been hired to conduct the transaction. Presuming this has occurred, the middleman coordinates with the real estate agent or broker to ensure that the agreed-upon referral fee is paid to the builder. When this occurs, the middleman forwards the referral fee to the developer or builder on behalf of the developer or to an LLC after subtracting the commission that has been previously agreed upon between the middleman and the developer or builder.

One attractive feature for the developer or builder is that, customarily, home prices continually increase over time. Thus, in the future, when the home is re-sold and the referral fee is to be paid, since the referral fee is preferably calculated as a percentage of the real estate commission to be earned, that referral fee appreciates over time proportionally to the degree of appreciation of the home that is the subject of the agreement. In this way, in some fashion, the-referral fee paid to the developer or builder is in the nature of an investment that pays an enhanced return based upon appreciation of the home.

One advantage of the present invention is that it provides a computer system for creating and managing future real estate agreements and for facilitating payment to a developer or builder of a referral fee, according to the present invention. The computer system may be implemented over a conventional network and include an “n-tier” software platform, which controls the operation of the system.

Another advantage of the present invention is that it provides a computer system that automatically and continuously monitors various realty data sources to detect proposed, pending and/or completed real estate transactions that trigger obligations under a future real estate agreement. Once an obligation has been triggered, the system may be used to notify the relevant parties and facilitate payment resulting from fulfilled obligations.

Another advantage of the present invention is that is provides a multidimensional, relational database that can be used to determine when an obligation under a future real estate agreement has or may become due, based on a variety of data.

According to one aspect of the present invention, a system is provided for creating and managing future real estate agreements. The system includes: a relational database for storing records regarding the future real estate agreements; and at least one computer system that is communicatively coupled to the relational database and that is adapted to monitor events to detect when an obligation under one of the future real estate agreements has or may become due.

According to another aspect of the present invention, a computerized method for managing future real estate agreements is provided. The method includes: creating an electronic record describing a future real estate agreement; storing the electronic record in a relational database; and monitoring real estate transactions to detect when an obligation under the future real estate agreement has or may become due.

According to another aspect of the present invention, a computer-readable medium is provided. The computer-readable medium has computer-executable instructions for performing a method for managing future real estate agreements including the steps of: creating an electronic record describing a future real estate agreement; storing the electronic record in a relational database; and monitoring real estate transactions to detect when an obligation under the future real estate agreement has or may become due.

According to another aspect of the present invention, a method for creating and managing future real estate agreements is provided. The method includes the steps of: storing records of future real estate agreements; and monitoring transactions to detect when an obligation under a future real estate agreement becomes due. The method may also include the steps of: notifying affected parties of the obligations that have become due under the future real estate agreements; and facilitating payment to a participant resulting from a fulfilled obligation under a future real estate agreement.

These and other advantages, aspects and features of the present invention will be better understood from the following detailed description of the preferred embodiment when read in conjunction with the appended drawing figures.

### BRIEF DESCRIPTION OF THE DRAWINGS

FIG. 1 is a block diagram illustrating the general operation of a method for creating and managing future real estate agreements, according to the present invention.

FIG. 2 is a schematic diagram illustrating the broad functionality of one embodiment of a Future Realty System and Database, according to the present invention.

FIG. 3 is a schematic representation of one embodiment of a method for creating and managing future real estate agreements from the perspective of a middleman.

FIG. 4 is a schematic representation of one embodiment of a method for creating and managing future real estate agreements from the perspective of the developer or builder.

FIG. 5 is a schematic representation of one embodiment of a method for creating and managing future real estate agreements from the perspective of the buyer or purchaser.

FIG. 6 is a schematic representation of one embodiment of a method for creating and managing future real estate agreements from the perspective of the real estate broker.

FIG. 7 is a schematic diagram illustrating the interaction between one embodiment of a Future Realty System and Database and various users/data sources, according to the present invention.

FIG. 8 is a block diagram illustrating a software platform that may be used to implement the Future Realty System and Database, shown in FIG. 7.

FIG. 9 is a schematic diagram illustrating a hardware platform that may be used to implement the Future Realty System and Database, shown in FIG. 7.

FIG. 10 is a process flow diagram illustrating an exemplary operational flow of one embodiment of the Future Realty System, shown in FIG. 7.

FIG. 11 is an exemplary Entity-Relationship diagram, depicting the data elements that may be contained within the Future Realty Database and the interaction between these elements.

### DETAILED DESCRIPTION OF THE EMBODIMENTS

The present invention provides a system and method for creating real estate agreements that offer a present financial incentive in exchange for an obligation to use a select real estate provider in a potential future transaction (hereinafter referred to as “future real estate agreements”). The system and method store a record of the future real estate agreement and monitor events that cause the obligation to become due. In the preferred embodiment, the system and method are implemented by use of one or more computer systems and relational databases, and one or more software components that control the general operation of the computer system.

The following describes the method and system of the present invention as follows: (i) Section I describes the general method of creating and managing future real estate agreements, according to the present invention; (ii) Section II describes an example of a method for creating and managing future real estate agreements that employs a “middleman”; and (iii) Section III describes a computer system for creating and managing future real estate, according to the present invention.

I. General Method

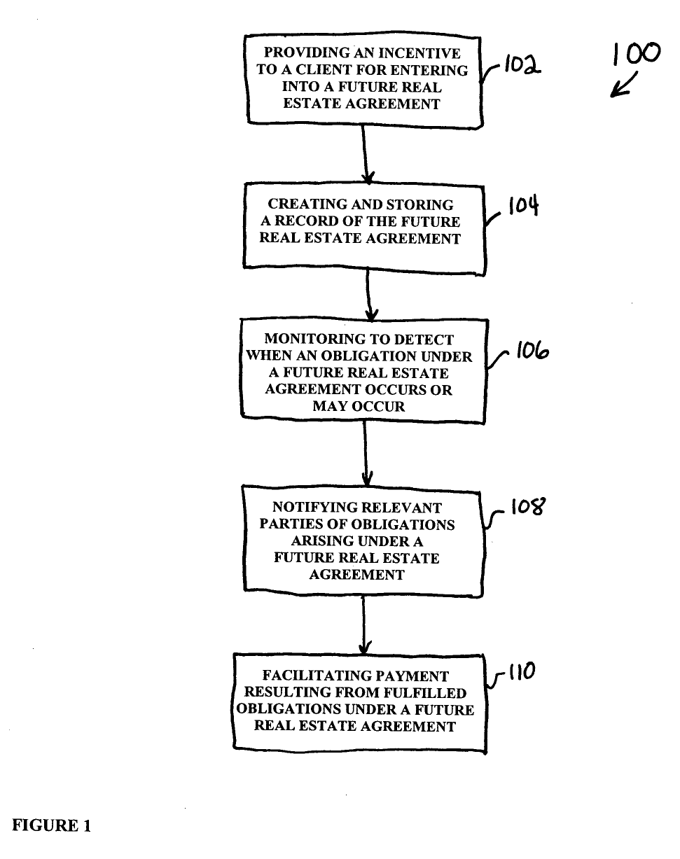

FIG. 1 illustrates a general method 100 for creating and managing future real estate agreements, according to the present invention. As described more fully and completely below, each of the steps of method 100 may be performed in various manners and by different parties. In the preferred embodiment, the method 100 includes the following steps: (i) step 102—providing an incentive to a client for entering into a future real estate agreement; (ii) step 104—creating and storing a record of the future real estate agreement; and (iii) step 106—monitoring events and transactions to determine when an obligation under the future real estate agreement arises. The method may also include: (iv) step 108—notifying relevant parties of obligation(s) arising under a future real estate agreement; and (v) step 110—facilitating payment resulting from fulfilled obligations under a future real estate agreement. Each of these steps is described in more detail below.

Step 102 involves providing an incentive to a client (e.g., a buyer in a real estate transaction) to enter into an agreement with a real estate service provider (“provider”) that includes a future obligation (“future real estate agreement”). In the preferred embodiment, the client is a buyer who is purchasing real estate. The incentive is preferably a financial incentive, such as a reduction in purchase price, an elimination or reduction in certain closing costs, commissions, service charges or fees, cash back at closing, and the like. The incentive provides valid consideration for the client entering into the future real estate agreement with a select provider. The term “select provider” may refer to a specific broker chosen by the party offering the financial incentive selected, or a broker chosen by the client from a group of brokers selected by the party offering the financial incentive.

The future real estate agreement is an agreement by the client to use a select provider in a future real estate transaction and may include: an agreement that the client will list the home for sale with a select provider (e.g., a real estate agent or broker); an agreement to allow a select provider (e.g., a real estate agent or broker) to represent the client in the purchase of a subsequent home; an agreement to use a select provider (e.g., a mortgage lender) for a subsequent or refinanced mortgage; an agreement to use a select provider (e.g., a title company, home owner's insurer or other real estate service provider) in a subsequent real estate transaction; and the like. Such future real estate agreements are very desirable to real estate service providers, since they add a significant future revenue stream with little or no up front, out-of-pocket cost.

The incentive may be provided by any party interested in securing the future real estate agreement. For example, the incentive may be provided by a builder, developer, third party and/or “middleman” who may effectively assign the right to a broker for a flat fee or who may enter into an agreement with a select broker to receive a referral commission from any revenue received by the broker resulting from the future real estate agreement. Alternatively, the incentive may be provided by the select provider who will directly benefit from the future real estate agreement, such as a real estate agent or broker who will receive the future listing and/or represent the client in the purchase of a subsequent home (e.g., pursuant to a buyer/broker agreement), a lender who will provide the client with a subsequent or refinanced mortgage and/or a title company or other service provider that will represent the buyer in a subsequent transaction.

To better understand the operation of this first step 102, a few non-limiting examples are provided below:

1. A builder or developer may provide an incentive, such as a reduction in price or closing costs to a buyer (i.e., the client) in exchange for the buyer agreeing that when the buyer (who becomes the owner) decides to sell the home, the buyer must list the home for sale with a real estate broker that has entered into an agreement with the builder. The agreement between the builder and real estate broker may provide that the agent pay the builder a referral fee upon receiving rights to the future listing or upon the subsequent sale of the home.

2. A builder or developer may provide an incentive, such as a reduction in price or closing costs to a buyer (i.e., the client) in exchange for the buyer agreeing to use a select mortgage lender, broker, title company, home owner's insurer, and/or other real estate service provider in relation to the purchase of the home, and/or in relation to the purchase of a subsequent home. The agreement between the builder and the real estate service provider may provide that the provider pay the builder a referral fee upon receiving rights to the future real estate agreement or upon receiving compensation resulting from the future real estate agreement.

3. A real estate broker representing the client in the sale or purchase of a home may offer the client a reduced commission on the sale in exchange for an agreement by the client to use the real estate broker (or a different real estate broker) for the purchase of a subsequent home, or for an agreement by the client to list a new home with the broker (or a different broker) when the client decides to sell the new home.

4. A mortgage lender or broker providing a mortgage to the client may offer the client reduced service charges, costs, fees and/or points in exchange for an agreement by the client to use the lender or broker for any potential re-finance of the loan, a second mortgage on the home, a home improvement loan, a mortgage on a subsequent home, or any other mortgage services. Alternatively, the mortgage lender may offer such a discount in exchange for the client agreeing to use a select real estate broker in the purchase of a new home, or to list the home with a select real estate broker when the client decides to sell the home.

5. A title company, insurer or other real estate service provider representing the client in a present real estate transaction may offer the client reduced costs or fees in exchange for an agreement by the client to use the title company, insurer or other real estate service provider in a future real estate transaction. Alternatively, the real estate service provider may offer such a discount in exchange for the client agreeing to use a select real estate broker in the purchase of a new home, or to list the home with a select real estate broker when the client decides to sell the home.

As will be appreciated to those skilled in the art, a multitude of other combinations may be possible, according to the present invention.

Step 104 involves creating and storing a record of the future real estate agreement. Preferably, an interested party to the transaction (e.g., a provider, builder, developer, third party or middleman) creates the record in electronic form by use of a computer system, and enters it into a relational database (e.g., a multidimensional relational database or “data cube”). This step, and the inventive method in general, may be performed and/or facilitated by use of one or more computer systems (hereinafter referred to as the “Future Realty System”) and relational databases (hereinafter referred to as the “Future Realty Database”).

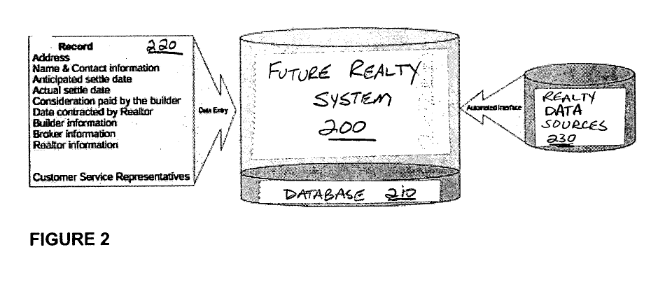

FIG. 2 is a schematic diagram showing the broad functionality of one embodiment of a Future Realty System 200 and Database 210, which may be used to perform step 104 and other steps of the present invention. As shown in FIG. 2, the records 220, which are entered into the database 210, may include information about the future real estate agreement such as: the address of the property at issue, the name, address, phone number and other identification information of the real estate provider(s) (e.g., real estate agent, broker, lender, title company, insurer) associated with the future agreement, the name of the client, relevant dates of the transaction/agreement, consideration information, and related data. The record 220 may also include a “transaction type” descriptor, which describes the type of transactions that will trigger an obligation under the agreement, such as the sale of the associated property, the purchase of real estate by the associated client, a mortgage of the associated property by the client, a mortgage of other real estate by the client, and the like. The record 220 may further describe the nature of the obligation(s) created by the future agreement (i.e., what the client has agreed to, such as the use of a select agent or broker for a future listing or purchase, the use of a select lender for a mortgage, or the use of a select title company, insurer or other real estate service provider for a particular real estate transaction). The record 220 is preferably added to the Future Realty Database 210 with other similar future real estate agreement records. The Future Realty System 200 and Database 210 may be used, provided and maintained by an operator of the system such as a real estate service provider, builder, developer, third party or middleman. As shown, customer service representatives (or listing analysts) may enter the electronic records 220 into the Future Realty System 200. An operator may use the Future Realty System 200 to periodically check the Future Realty Database 210 to detect when an obligation within one of the future agreements arises. The structure and operation of the Future Realty System 200 and Database 210 is more fully and completely discussed in Section III.

Step 106 involves monitoring events and transactions to determine when an obligation under one of the future agreements is about to arise or has already arisen. In the preferred embodiment, an operator uses the Future Realty System 200 to monitor and/or query one or more realty data sources 220, which provide information (“source information”) regarding proposed, pending and completed real estate transactions (“monitored transactions”). In alternate embodiments, the sources may be monitored or queried manually. In the preferred embodiment, the Future Realty System 200 may monitor and/or receive information from: (i) one or more Multiple Listing Services (MLS), i.e., systems by which a number of real estate firms share information about homes that are for sale in a geographical region; (ii) Internet sites and databases where properties may be listed for sale; (iii) lien databases that provide mortgage information; and (iv) other electronic databases, such as internal and external real estate broker and lender databases. As new properties appear for sale on the MLS, Internet sites and/or databases, the addresses of the properties are checked with the Future Realty Database 210 to determine whether a future real estate agreement is associated with that property (e.g., if the current owner has agreed to list the property with a select agent or broker, or use a particular real estate provider for the sale, purchase or other transaction). Additionally, the monitoring may include checking the names of individual sellers, purchasers and mortgagors of properties for the monitored transactions to the records of the Future Realty Database 210 to determine whether a future real estate agreement is associated with the individuals (e.g., to determine if an individual has agreed to use a particular real estate provider for a sale, purchase, mortgage or other transaction).

If a “match” is found between the source information and a property or individual in the Future Realty Database 210, the Future Realty System 200 may further automatically determine whether the monitored transaction triggers an obligation under a future real estate agreement. The Future Realty System 200 can make this determination by comparing the monitored transaction (e.g., a sale, purchase, mortgage or other real estate transaction) to the transaction type descriptors contained within the records of the Future Realty Database 200. If the transactions are of the same type, then an obligation has been triggered. In one embodiment, numerical values may be assigned to the monitored transaction and transaction type descriptors in order to facilitate the comparison.

Alternatively, if a “match” is found between the source information and a property or individual within the Future Realty Database 210, the information regarding the monitored transaction (e.g., the buyer, seller, and the transaction type) and the future real estate agreement (e.g., the information contained within the associated record) may be outputted (e.g., printed, displayed and/or transmitted) and manually examined to determine whether an obligation under a future real estate agreement has been triggered.

Once it is determined that an obligation has been triggered, the relevant parties (e.g., the client and/or real estate service provider) are notified step 108. The notification required may depend on the identity of the operator of the system, i.e., who is maintaining and monitoring the Future Realty Database. If the affected provider is operating the system, the provider can take direct action to notify the client and preserve its rights to the obligation. If a third party (e.g., a builder or developer) or middleman is operating the system, the third party may contact both the client and the affected provider, who may take steps to preserve and enforce the obligation. Alternatively, the Future Realty System 200 may be used to automatically generate electronic notifications (e.g., by use of email, IM, SMS, or other electronic messaging service) to affected parties based on the contact information contained in the electronic records 220, in response to a detected “match”.

Step 110 involves facilitating payment to the relevant parties or participants. This step will vary based on the terms of the future real estate agreement, the parties involved, and the nature of the transaction. In the simplest scenario, where a provider operates the system and no third party is involved (e.g., a builder, developer, or middleman), the step typically includes the provider receiving payment (e.g., a commission) from the proceeds of the transaction. For example, if the provider is a real estate broker or agent, the broker or agent may act as the listing agent for a future real estate transaction and be paid a percentage of overall cost of the transaction as a commission. If the provider is a mortgage broker or lender is the provider, the mortgage lender may receive the benefit of providing a mortgage for the client in the future. The mortgage lender or broker could then receive proceeds including points, costs and other fees associated with the future transaction (i.e., mortgage). If the provider is a title company, the title company may represent the client in the transaction and receive associated fees and costs.

As explained above, a third party may be involved in selecting a broker for the future real estate agreement, and may obtain a referral fee from the broker. Preferably, the third party will collect a percentage from the broker after the transaction is completed. The third party may also require the referral fee “up-front” or as soon as the future real estate agreement is assigned. For example, in the case where a builder operates the Future Realty System 210 and assigns a particular real estate broker to a future real estate agreement, the builder may collect payment from the agent after the future transaction is completed and the agent is compensated and/or receive an “up-front” fee from the agent as soon as the agreement is assigned.

When a middleman is involved, such as between a builder or developer and a broker, the middleman may collect payment from the broker after the transaction is complete and deliver a portion of the payment to the builder or developer. The operation of this step with respect to a middleman is discussed in greater detail in the following section. In any of these scenarios, the Future Realty System 200 and Database 210 can be used to track receivables and disbursements to ensure that all relevant parties are paid. One example of this tracking process is described below in Section III. D.

II. Method for Creating and Managing Future Real Estate Agreement Using a Middleman

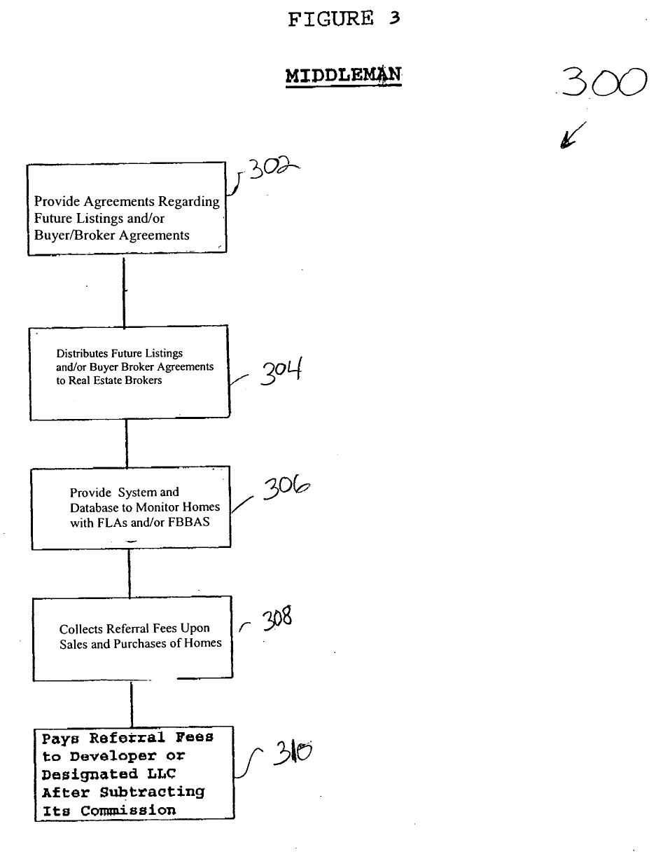

The method of the present invention will now be described in relation to an example that uses a “middleman” to create and manage future real estate agreements. In this example, the middleman facilitates and manages the transaction and serves as an intermediary between a builder or developer (the “developer”) and a real estate broker in this example. FIG. 3 illustrates a method 300 for creating and managing future real estate agreements from the perspective of a middleman. In the present embodiment, the middleman can be important to the entirety of the method for a number of reasons. In the present embodiment, the middleman may create the agreement forms (e.g., by use of the Future Realty System) that are signed between the middleman and a real estate agent, broker or firm, between the middleman and the developer, and between the developer and the prospective purchaser, as shown in step 302. For example, the middleman may create agreements regarding future listings (FLAs) and/or buyer/broker agreements (FBBAs).

In step 304, the middleman assigns the future real estate agreement, such as future listing agreements (FLAs) and/or buyer/broker agreements (FBBAs) to real estate brokers with whom the middleman has a relationship. For instance, in operating the inventive method, the middleman may create a network of real estate brokers that agree to pay a referral fee in exchange for a future listing of a home to be sold at some indeterminate time in the future, or for a future buyer/broker agreement. Given the advertising costs of a real estate firm, it is not difficult to imagine successful real estate firms entering into such an agreement because, without advertising costs, the inventive method provides a steady stream of listings to the firm. The commissions required to be paid in exchange for the future listings may not have to be paid until the future listing results in a future sale. The commission charged by the middleman for entering into the agreement may be in the range of 30 to 35%, which is far less than the costs that would be incurred by the firm in obtaining such a listing. This makes the method attractive to the real estate firm. In addition, a fee may be provided “up-front” by the real estate broker.

As shown in step 306, the middleman provides the Future Realty System and Future Realty Database to monitor real estate transactions involving homes subject to a future real estate agreement (e.g., a future listing). When a future real estate agreement is entered into between a developer or builder and a prospective and soon-to-be purchaser, a copy of the agreement is forwarded to the middleman, who creates an electronic record of the transaction. For example, the middleman may enter the home address, tax map information, and/or purchaser name into the Future Realty System and Database so that the status of the home in question can be closely monitored. In the preferred embodiment, the middleman provides the developer with software that allows the developer to generate the future real estate agreements on a computer system. Once the buyer has executed the agreement, the developer may electronically transmit the agreement to the middleman by use of the Future Realty System. This allows the middleman to easily create an electronic record for entry into the Future Realty Database. Alternatively, the Future Realty System may receive the electronic transmission and automatically create an electronic record and enter it into the Future Realty Database.

One way of monitoring the home is to ensure that whenever the home, by an identifier such as the owner's name, the street address, the tax map number, the subdivision identifier, or the like, is listed for sale, the middleman will become apprised of this fact to ensure that the sale of the residence, sometime in the future, occurs in accordance with the future real estate agreements that have been reached.

When a home that is subject to agreements in accordance with the method is sold, at settlement, the provider pays the referral fee to the middleman. The middleman deposits the funds, subtracts an agreed-upon commission, as shown in step 308, and forwards the rest of the funds to the developer or builder, as shown in step 310. In some jurisdictions, the developer, in order to legally receive the funds, must also have a broker's license. Alternatively, the developer or builder can employ a broker for the purpose of receiving the fees. As a further alternative, the developer can form business entity such as a limited liability company (LLC). The referral commissions would then be paid to the LLC. When the net referral fee (the referral fee less middleman commission) is paid to the business entity, the business entity pays the developer or builder a distribution based upon the value of the developer's or builder's ownership share.

In this example, the middleman can provide numerous services including the following:

1. Providing training to real estate agents and brokers to effectuate the inventive system.

2. Development of a sophisticated computer program to store data for the various properties covered by agreements in accordance with the teachings of the present invention so that monitoring can be conducted, particularly of the Multiple Listing Service, in order to track, collect and distribute referral fees back to the developer or builder while collecting middleman commissions.

3. The middleman can create a method of ensuring the future home seller's willingness to participate in the system in accordance with the teachings of the present invention, including providing a program to track the package of incentives that are currently offered by developers or builders when securing mortgage and title work from the prospective purchaser.

4. The middleman can provide a schedule and other information that helps the real estate agent or broker to maintain regular contact with the prospective purchaser and future owner during the term of ownership of the home in question.

5. Through a list of real estate agents and brokers, the prospective purchaser is able to choose one of a number of agents or brokers that the prospective purchaser prefers presuming those agents and brokers are listed on the list of approved entities that have pre-existing agreements with the middleman.

6. If desired or appropriate, the middleman can develop a nationwide sales force to contact developers or builders and obtain their agreements to enter into the program and will develop a list of agents and brokers who are willing to cooperate in the system.

7. Additionally, the middleman can develop a process for delivering the required contracts and: any necessary marketing materials to participating developers or builders while developing a tracking system to ensure that all executed contracts are received and processed by the middleman.

8. With the help of outside counsel, the middleman can create agreements that are necessary for all participating parties to the transaction including prospective purchasers and homeowners, developers or builders, real estate agents and brokers, and the middleman.

9. As explained above, an operator of the system and method (e.g., a middleman) may create a list of participating real estate agents and brokers continually update the list when agents are added and subtracted. If a broker is subtracted, all future listings may be given to another broker in its place.

10. A method may also be devised, as desired, to assist the middleman in assigning future listings to the various real estate agents and brokers for whom agreements have been reached. If the prospective purchaser has a preference of agent or broker, and that preference is on the approved list, that agent or broker will be chosen. Otherwise, a random selection system can be devised and implemented.

11. The middleman can direct the builder to create an LLC for receipt of net referral fees.

The computer system that is implemented by the middleman, i.e., the Future Realty System, may accomplish the following:

(1) Create a record for each prospective purchaser that signs up for the inventive system. This information may comprise the address of the property at issue, the name, address, phone number and other identification information of the real estate provider(s) (e.g., real estate agent, broker, lender, title company, insurer) associated with the future agreement, the name of the client, the date the transaction/agreement was entered, the name and address of the developer or builder, the date entered, a transaction type descriptor, the nature of the obligation, and related data. The Future Realty Database is preferably robust and provides the necessary redundancy, reliability and performance to provide high-speed relational access to any single record or group of records.

(2) Collect up-to-date real estate listing information from every necessary Multiple Listing Service on a regular basis.

(3) Each of these systems may consist of different platforms and applications for which a customized interface must be developed, tested and launched.

(4) The collected data may be sorted by region and compared against the master database of participants in the inventive program to ensure any listing that is a listing of a property for which an agreement has been entered is tracked to the conclusion of a transaction.

(5) If a listing is discovered that has not been entered for a property by the real estate agent or broker to whom it was assigned, an exception report may be generated and customer service may follow-up with the assigned real estate agent or broker immediately to see what has happened. Also, the middleman may notify the broker that a buyer/broker agreement may be possible.

(6) Once the transaction is recorded as a completed sale, accounting may be notified and a receivable recorded for that particular real estate agent or broker.

(7) If the listing is pulled without a sale, a report may be generated and a communication sent to the participating real estate agent or broker.

(8) Once a listing or buyer/broker agreement has generated revenue, it may be deleted from the system to ensure continued performance without old data causing degradation of system performance.

(9) Information on the sale may be entered into a separate data base so future product offerings from the inventive system can be sent to the new homeowner.

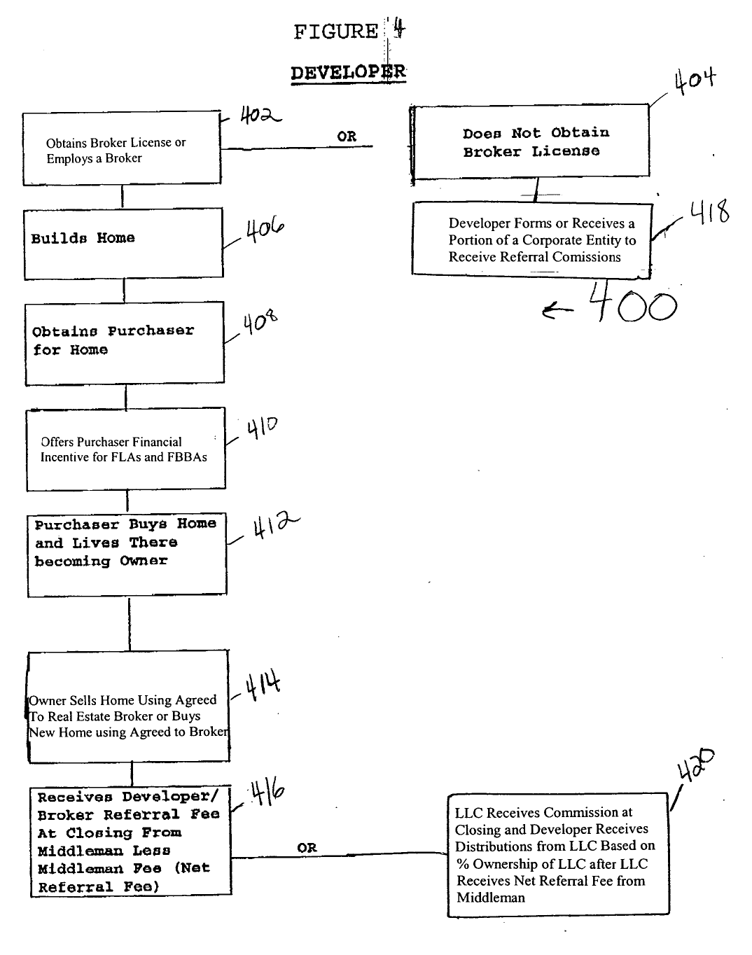

FIG. 4 illustrates a related method 400 from the perspective of the developer or builder. In order to facilitate collection of the referral fees, the developer or builder obtains a broker's license or employs a broker, as shown in step 402. Alternatively, the developer may form and/or receive a portion of a corporate entity such as an LLC, which receives the referral commissions, as shown in steps 404, 418. The developer or builder builds a home, as shown in step 406, and obtains a prospective buyer or purchaser for the home, as shown in step 408. The developer may obtain a buyer by any known method such as advertising in newspapers, journals and magazines, hiring a real estate agent to find buyers, or any other desired method. When the developer or builder is deciding upon the price for the home, the developer or builder may include anticipated closing costs in the pricing.

During the course of negotiations with the prospective purchaser concerning the home price and the closing costs, the developer or builder offers the prospective purchaser a financial incentive in exchange for a future listing agreement, as shown in step 410. The future listing agreement may involve the prospective purchaser agreeing that when, eventually, the prospective purchaser (who now has become the owner) decides to sell the home, the owner will list the home for sale with a select real estate broker (e.g., a certain real estate broker within the middleman's network), or a real estate broker known to the prospective purchaser provided that real estate broker has entered into an agreement with the middleman concerning the inventive method. The agreement between the developer or builder and prospective purchaser is reduced to an agreed-upon writing and thereafter the prospective purchaser actually purchases the home and either lives there or keeps it for investment, renting it out or doing whatever he or she chooses with it, as shown in step 412.

Eventually, and on average, this occurs every six (6) years or so, the owner (previously known as the prospective purchaser) decides to sell the home. In accordance with the agreement made with the developer or builder in exchange for the financial incentive that was given when the home was originally purchased, the owner engages the services of the pre-chosen real estate agent or broker to list and sell the home. The home is sold using that agreed-upon real estate broker, as shown in step 414. When the home is finally sold, the developer or builder receives the referral fee from the middleman after the middleman has subtracted his commission, as shown in step 416. The developer may receive the referral fee in one of three ways. The three ways are (1) directly, (2) via a broker, or (3) as a distribution from the corporate entity or LLC, as shown in step 420. From the perspective of the developer or builder, the fee collected is enhanced through appreciation of the home over time. For example, assuming that the home sold for $200,000.00, the listing commission is 3% (or $6,000.00), and the total referral commission is 35% of the listing commission (or $2,100.00). Of the 35%, the developer may receive 20% (or $1,200.00) and the middleman may receive 15% (or $900.00).

It is easy for a developer or builder to incorporate the present invention into his current method of operating their business. The appropriate clauses that effectuate the present invention are integrated into the contracts the developer or builder currently uses as additional clauses included representation of relationships with title insurance agencies, closing agents and attorneys, and real estate brokers so that any potential conflict issues can be considered and waived by the prospective purchaser in connection with receipt of the financial incentive. Upon completion of contracts including the appropriate clauses, the developer or builder sends copies of the completed contracts to the middleman for entry into the middleman's computer.

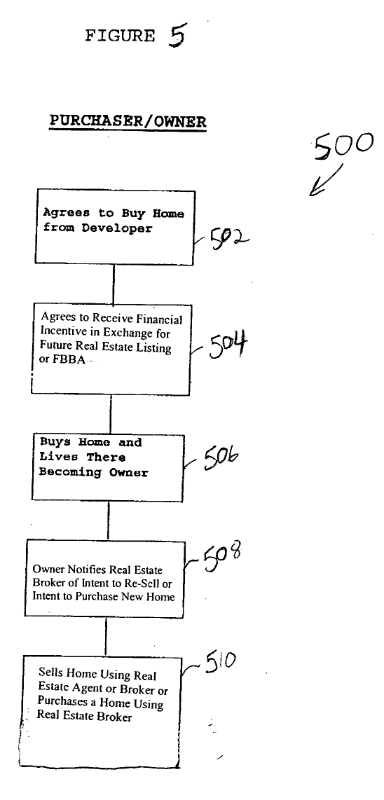

FIG. 5 illustrates a related method 500 from the perspective of the prospective purchaser and actual eventual owner. In step 502, the prospective and eventual purchaser agrees to buy a home from the developer or builder. During the course of the negotiations between the prospective purchaser and the developer or builder, the prospective purchaser agrees to receive a financial incentive in terms of a reduction in purchase price or closing costs in exchange for agreement that when the prospective purchaser has purchased the home and decides at some time in the future to sell the home, the prospective purchaser, then the owner, will list the home for sale with a select real estate broker, as shown in step 504. With this agreement in place, the prospective purchaser purchases the home by entering into a closing, as shown in step 506.

When the time comes that the owner decides to sell the home, in accordance with the agreement made prior to closing the purchase, the owner contacts the real estate broker and engages their services to sell the home, as shown in step 508. The home is sold and the real estate broker pays the referral fee required in accordance with its contract with the middleman, as shown in step 510.

One aspect that encourages a prospective purchaser to enter into an agreement involving the method disclosed herein is that the receives an immediate financial incentive in exchange for a mere promise to use a selected broker for a subsequent resale of the home. Although the purchaser is legally bound to honor that promise, it imposes no cost on the purchaser at the time of the assignment, thereby making the agreement very attractive to the purchaser.

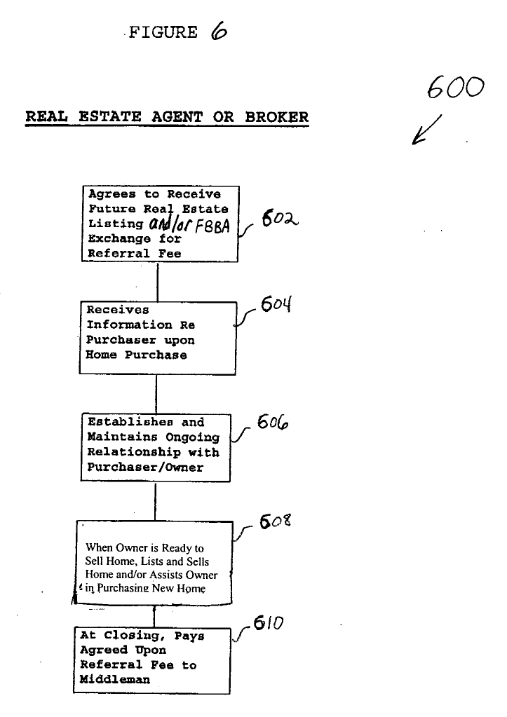

FIG. 6 illustrates a related method 600 from the perspective of the prospective purchaser and actual eventual owner. In this method, a real estate agent or broker enters into an agreement with the developer or middleman in which the agent or broker agrees to receive a future real estate listing and/or a future buyer/broker agreement in exchange for payment of a referral fee upon sale of the underlying home, as shown in step 602. When the underlying home is purchased from the developer or builder, the middleman contacts the real estate agent or broker to provide information concerning the purchaser, now owner, so that the real estate agent or broker can contact the owner and establish an amicable relationship with them, as shown in step 604. The real estate agent or broker, in accordance with its agreement with the middleman, maintains that relationship by periodically contacting the owner in a non-intrusive way to maintain the relationship, as shown in step 606. When the owner is ready to sell the home, in accordance with the owner's agreement with the developer or builder, the owner contacts the real estate agent or broker and enters into a listing agreement with the real estate agent or broker so that the real estate agent or broker can sell the home for the owner, as shown in step 608. Alternatively or additionally, the real estate broker may assist the owner in purchasing a new home, according to the buyer/broker agreement.

The real estate agent or broker sells the home to the owner and pays the agreed-upon fee to the middleman at closing, as shown in step 610. As explained hereinabove, the middleman subtracts its commission for handling the entire transaction and pays the remainder to the developer or builder. If possible, during the course of the relationship with the owner prior to entering into a sales agreement, the real estate agent or broker periodically contacts the middleman to keep the middleman apprised of the status of the owner's intentions and affirmatively contacts the middleman when a real estate listing contract has been established for sale of the home.

The benefits of the inventive method for real estate agents and brokers are numerous including the following:

(1) Saves time prospecting for new clients.

(2) Dramatically reduces the expensive proposition of advertising for listings.

(3) More efficient connection to potential home sellers is accomplished.

(4) Begins the relationship between the real estate agent or broker and the owner.

(5) Gives the real estate agent or broker an opportunity to contact a home seller in advance of the listing of the home.

(6) Offers an opportunity to show the home seller the real estate agent or broker's local knowledge.

(7) Offers the opportunity for a personal visit by the real estate agent or broker to the owner.

(8) Offers a chance to maintain contact through e-mail and newsletter with the owner.

(9) The real estate agent or broker is introduced to family and friends of the prospective purchaser and eventual owner.

(10) Building of new business in a community by having a presence through signage when that home is eventually listed.

(11) By agreeing to be a part of the inventive system, the middleman will assign its rights to the listing to participating real estate agents or brokers. The real estate agent or broker agrees to pay a referral fee and an administrative fee totaling, for example, 30-35%, from the listing half of the real estate commission to the middleman once the property sells.

(12) The real estate agent or broker agrees to monitor the owner to ensure they list their home with the real estate agent or broker when the homeowner decides to sell.

(13) Once the home is listed, the real estate agent or broker must notify the middleman. When the property is sold, the real estate agent or broker is required to wire the referral fee within 48 hours of closing.

In this manner, the present invention has been described in relation to an exemplary method employing a middleman. It should be appreciated that the suitable variations may occur based on the types of relationships that are present and who is operating the Future Realty System.

III. Future Realty System and Database

In the preferred embodiment, the present invention is implemented using one or more computer systems (the “Future Realty System”) and relational databases (the “Future Realty Database”). The following discussion describes a general overview of the Future Realty System, the preferred software and hardware platforms that may be used to implement the Future Realty System, and a detailed description of the operational flow of one embodiment of the Future Realty System.

A. General System Overview

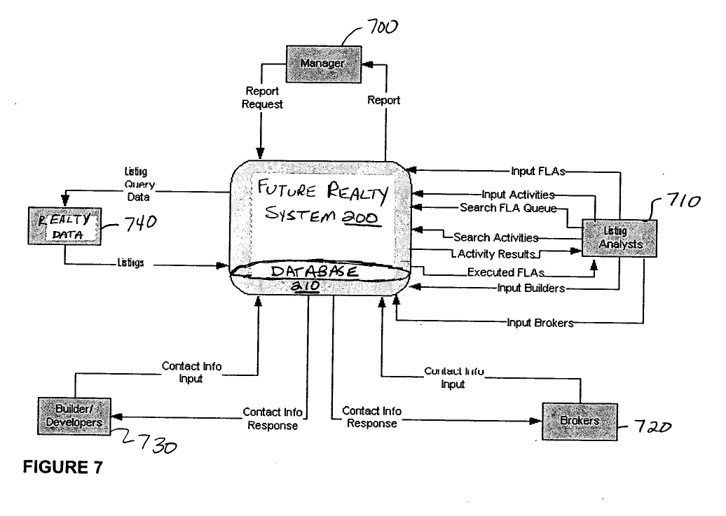

FIG. 7 illustrates an overview of the Future Realty System 200 and Database 210 and various data sources and users that may interact with the Future Realty System 200. As described below, the Future Realty System 200 and database 210 may be implemented by use of one or more software components operating on one or more conventional computing devices, resources and/or servers and one or more relational databases (e.g., multidimensional relational databases).

Several data sources and user types may interact with the Future Realty System 200 during its operation, including a manager user type 700, a listing analyst user type 710, a broker user type 720, a builder or developer user type 730, and/or realty data sources 740. The above-delineated users and data sources are described below.

The manager user type 700 may represent an operator of the Future Realty System 200. In the preferred embodiment, the manager 700 is a middleman, who operates and monitors the Future Realty System 200 on behalf of the participants. However, in alternate embodiments, the manager 700 can be a builder, developer or other real estate provider that is operating the system without a middleman. Managers 700 can interact with the Future Realty System 200 by inputting requests for reports. Managers will input and submit criteria via a user interface to generate reports. The result of this submission may be a generated report that can be viewed and printed from the user's browser application.

The reports generated may include predefined reports that match the strategic business management needs of the middleman or operator of the system, such as lists of proposed, pending and completed transactions that are covered by future real estate agreements contained within the database 210, reports of collection and disbursement activities, and the like. The reports may be accessible via a reports list provided by the software application, and may be generated within the user's browser as an HTML page. The report pages may include active links to different screens within the Future Realty System application for situations where greater detail is necessary. The report pages may also contain an option to generate a “printer-friendly” version for scenarios where hard copy reports are required. The content of the reports can be based upon the strategic business metrics requirements of the user.

The listing analysts user type 710 may input data from future real estate agreements, such as future listing agreements (FLAs) and/or future buyer/broker agreements (FBBAs), into the Future Realty System 200 to update and create electronic records, such as records 220. The listing analysts 710 may be employees or agents of the operator of the system, such as a middleman, builder or real estate provider. The listing analysts 710 may also search for and/or review executed future real estate agreements, which may be stored in an executed agreement database or queue (e.g., FLA Queue). The listing analysts 710 may subsequently input payment and collection activity data related to these executed agreements. They will have the ability to search all types of records to view and update the records as needed. Listing agents 710 may also input data to create records for the members or participants in the Future Realty System 200, such as records of the participating builders and brokers (e.g., builder and broker contact and/or identification information). Once this information is entered, the analysts 710 can monitor the activity of the participants in the Future Realty System 200.

The broker user type 720 may comprise real estate agents or brokers or other real estate service providers (e.g., lenders or title companies), who may be operating or participating in the Future Realty System 200. Brokers 720 can interact with the Future Realty System 200 by inputting data in order to update their company and/or contact information. Brokers 710 may also access their records via a self-service user interface and update address, phone and e-mail information. In one embodiment, brokers 720 may also access Future Realty System 200 to check the status (e.g., open, pending, closed) and/or terms of future real estate agreements to which the broker is a party and/or in which the broker has a vested interest.

The builder user type 730 may comprise builders or developers, who may be operating or participating in the Future Realty System 200. Builders 730 can interact with the Future Realty System 200 by inputting data in order to update their company and/or contact information. Brokers 730 may also access their records via a self-service user interface and update address, phone and e-mail information. In one embodiment, a builder 730 may also access Future Realty System 200 to check the status (e.g., proposed, pending, closed) of transactions and/or the terms of future real estate agreements to which the broker is a party and/or in which the broker has a vested interest. It should be appreciated that the builder type 730 may also comprise any other real estate service providers, such as mortgage lenders, realtors, insurers, title companies and other real estate service providers who receive FLAs and/or FBBAs in exchange for a financial incentive and provide the FLAs and/or FBBAs to the system operator (e.g., middleman).

The realty data sources 740 may comprise one or more data sources, which provide information (“source information”) regarding proposed, pending and completed real estate transactions (“monitored transactions”). In the preferred embodiment, the realty data sources 740 may include: (i) one or more Multiple Listing Services (MLS) or systems through which a number of real estate firms may share information about homes that are for sale in a geographical region, such as a Metropolitan Regional Information System (MRIS); (ii) Internet sites and databases where properties may be listed for sale; (iii) lien databases that provide mortgage information; and (iv) other electronic databases, such as internal and external real estate broker and lender databases. Data from home sales and/or other transactions (e.g., loans) will be compared to the electronic records to determine whether any matches exist between pending or executed transactions and future real estate agreements (e.g., FLAs, FBBAs). This comparison may be performed in the manner described above in Section I. The Future Realty System 200 may periodically send requests to the realty data sources 740, which may respond by transmitting a record set of data.

B. Preferred Software Platform

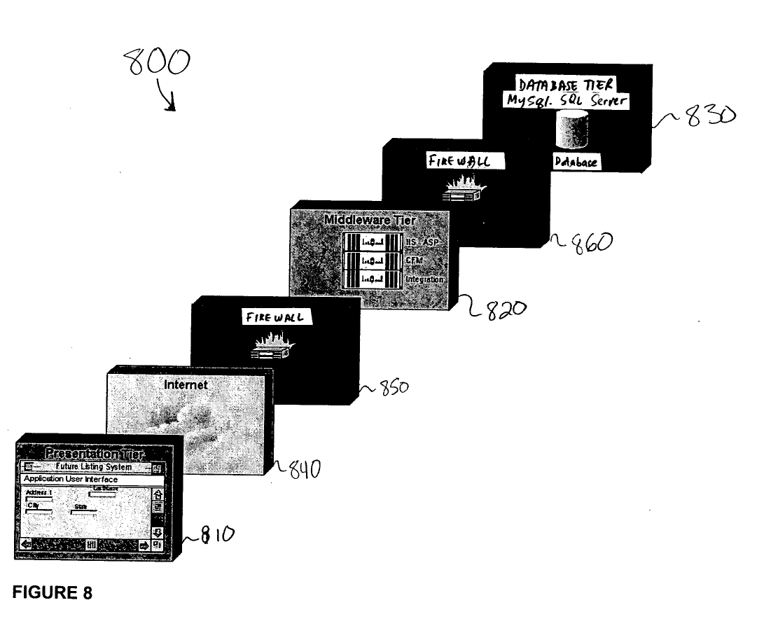

In the preferred embodiment, the Future Realty System 200 employs a software platform having an “n-tier” type architecture. The n-tier architecture is known in the art and is commonly used in today's web applications. In one embodiment, the software platform includes a 3-tier model, which is adapted to expand into additional tiers to allow for greater performance and scalability as needed. An important benefit of using a flexible architecture versus a static 3-tier model is that it provides the ability to break up the business logic from the Middleware tier into a more fine-grained model. FIG. 8 is a block diagram illustrating the preferred embodiment of the software platform 800. As shown, the platform 800 includes a presentation tier 810, a middleware tier 820 and a database tier 830. The presentation tier 810 may communicate to the middleware tier 820 by way of a network such as the Internet 840. Firewalls 850, 860 may be disposed between the middleware tier 820 and the presentation tier 810, and between the middleware tier 820 and the database tier 830, to prevent unauthorized access of the middleware tier 820.

In this architecture, the user's Web browser acts as a client within the presentation tier 810, the middleware tier 820 is supported by an application server (e.g., Macromedia ColdFusion), which handles the business logic of the system, and a Relational Database Management System (e.g., as SQL Server or MySQL database servers) handles database functions within the database tier 830. In the case of the Future Realty System 200, the middleware tier 820 may also contain provisions for integration with the external realty data sources 740. For example, the Future Realty System application may require data from external sources to be imported for comparison against future real estate agreement records to determine whether an obligation has become due. In the preferred embodiment, the primary application interface will extract data from the realty data sources 740, such as the Multiple Listing Service or MRIS, and will insert the appropriate data into the Future Realty Database 210. A known methodology (e.g., text file or XML transfer) may be employed for retrieving data from the data sources 740. The application architecture may further be adapted to allow for future application interfaces dictated by business conditions.

The following is a description of each of the portions or tiers of the preferred software platform for the Future Realty System 200.

Presentation Tier

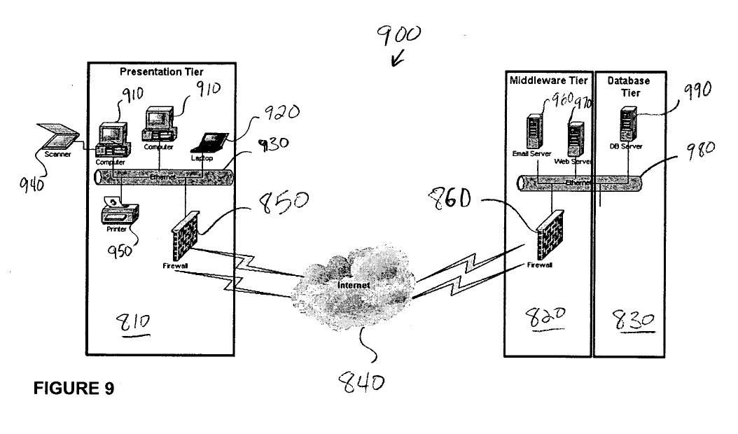

The presentation tier 810 comprises the application's user interface that is exposed to and used by the end users (e.g., brokers, developers, analysts) and system administrators (e.g., managers). The Future Realty System software application, presented in HTML and/or XML, will be delivered to the user via the Internet, and viewed through conventional Web-Browser applications running on the user's device. The presentation tier 810 collects user actions and delivers them to the middleware tier 820 where the business logic is contained. Additionally, users may consume information pushed out of the Future Realty System as email notifications through email client applications. The presentation tier 810 resides totally within the user's local environment as depicted in FIG. 9.

Middleware Tier

The middleware tier 820 may comprise an application server that contains the business logic for the Future Realty System application. The middleware tier 820 can dynamically generate and deliver HTML and scripting components for the application's user interface. This business logic contained within the application server enforces the rules or behavior embedded within the user interface that is served up to the user in the presentation tier 810. Additionally, the middleware tier 820 is responsible for interpreting the user's activity occurring in the presentation tier into transactions for adding, updating and retrieving data in the underlying database contained in the database tier. The middleware tier 820 may reside totally within the hosted server environment, and is shown in the middleware tier boundary in FIG. 9.

Database Tier

The database tier 830 provides the data and database services required to support the needs of the Future Realty System application. It may also contain certain database management services, such as SQL stored procedures or database views, to increase the performance of the application. The database tier 830 manages the storage and retrieval of information within the Future Realty Database 210. It is not responsible for the business rules for manipulating or delivering the data. For the Future Realty System application, all of the database tier data services will be provided by the Relational Database Management Server application, such as MS SQL Server or MySQL. The database tier 830 may reside totally within the hosted database server environment, and is shown in the Database Tier boundary in FIG. 9.

Future Realty System User Interface and Security

In the preferred embodiment, the software platform of the Future Realty System 200 is a Web-based application development architecture that provides a standardized platform for user interface development, data design, and application integration. Users will be able access the application from a conventional web browser (e.g., Internet Explorer or Netscape) anywhere there is available Internet connectivity. The entire interface application can run within the web browser. This web-based architecture will dramatically decrease the cost of software distribution and increase accessibility, allowing staff to work from anywhere.

The Future Realty System application may be constructed using standard HTML, CFML (ColdFusion Markup Language), JavaScript, CSS and/or DHTML technologies in order to provide users with intuitive user interfaces for accessing the business data (e.g., the electronic records and Future Realty Database) by use of a multitude of devices (e.g., personal computers, laptop computers, PDAs, mobile phones and the like). No special software beyond the standard browser applications is required.

The Future Realty System application may contain one or more auxiliary portals for brokers, builders and/or other real estate providers to update their respective company information. This portal may be assessable from the operator's (e.g., middleman's) corporate site, and may operate as a separate application. This portal may be supported by the same architecture used for the main Future Realty System application.

Access to the Future Realty System application can be maintained by the application server. Security roles may be applied to each user to appropriate control access to functions within the Future Realty System application. Access to the application data can be limited to the Future Realty System application and direct access to the Future Realty Database will be available only for the database administrator (e.g., manager 700).

Exemplary Relational Database Model

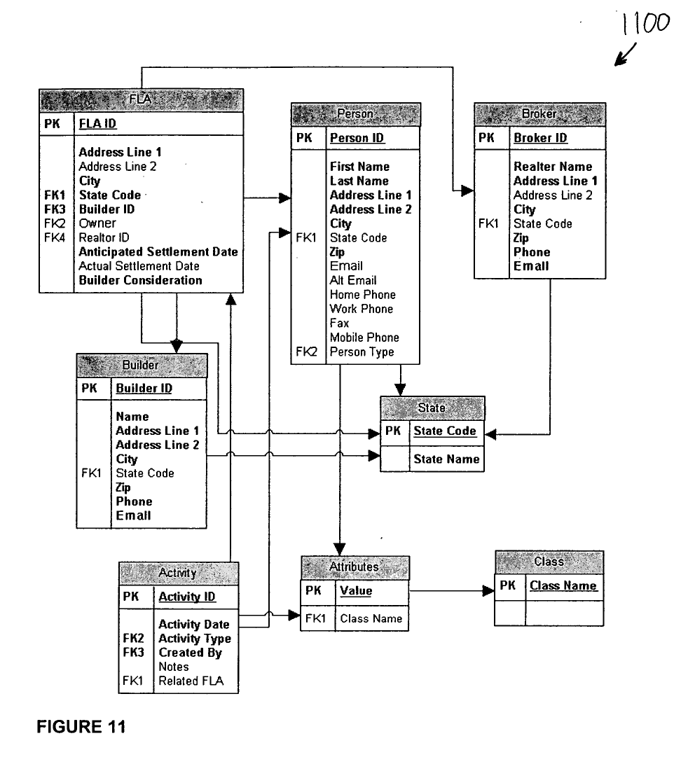

The database management portion of the Future Realty System application will be based on a standard relational database model containing the data elements necessary for operation of the business processes (e.g., monitoring and tracking of future real estate agreements, obligations, receivables, disbursements and the like). FIG. 11 illustrates one non-limiting embodiment of an Entity-Relationship diagram 1100, depicting the data elements that may be contained within the Future Realty Database 210 and how these elements interact. The diagram shown in FIG. 11 is adapted for a situation where the future real estate agreements comprise future listing agreements (FLAs), and the participants in the system include a builder or developer (Builder 730), one or more brokers or agents (Broker 720), and one or more prospective purchasers, who become owners (“Owner”) of properties sold by the builder. The data elements used in this example include the following entities:

FLA Entity (FLA): This entity stores data about the FLA agreements (e.g., address, city, state, builder, owner, realtor, anticipated settlement date, actual settlement date, builder consideration). This entity may also store similar data about FBBA agreements. Information about Builders, Owners, Brokers, and States for each of the entity instances are maintained through relationships to the Builder, Person, Broker, and State entities which houses data specific to those entity types.

Person Entity (Person): This entity stores data about the property owners (e.g., name, address, city, state, zip code, email address, telephone numbers, fax number, person type). Information about the states in which the owners reside is maintained through relationships to the State entity which houses data specific to that entity type.

Broker Entity (Broker): This entity stores data about the brokers and agents who are affiliated with the system (e.g., name, address, city, state, zip code, telephone number, email address). Information about the states in which the brokers reside is maintained through relationships to the State entity which house data specific to that entity type.

Builder Entity (Builder): This entity stores data about the builders or developers who are affiliated with the system (e.g., name, address, city, state, zip code, telephone number, email address). Information about the states in which the builders reside is maintained through relationships to the State entity which houses data specific to that entity type.

State Entity (State): This entity stores data about the state locations and is used to populate state values in the FLA, Person, Broker, and Builder entities.

Activity Entity (Activity): This entity stores data about the payment and disbursement activity related to FLA agreements (e.g., activity date, activity type (e.g., collection, disbursement, etc.), who the record was created by, miscellaneous notes regarding the activity, the related FLA). This entity contains a relationship to the FLA entity through which the corresponding agreement is identified. Information about the activity type is maintained through relationships to the Attributes entity which houses the activity type data records.

Attributes Entity (Attributes): This entity stores data that is used to populate miscellaneous values on related records. Information about the type or classification of the value is maintained through relationships to the Class entity which houses data specific to that entity type.

Class Entity (Class): This entity stores data about the value type locations and is used to populate state values on Attribute records.

As will be appreciated by those skilled in the art, additional and/or different data elements and relationships may be provided based on the participants using the system and the transactions being monitored.

C. Preferred Hardware Platform

The Future Realty System may be implemented using conventional and commercially available computer systems or independent microprocessor-based systems built specifically for use with the present invention. In the preferred embodiment, each of the computer systems may store at least a portion of the operating software, which directs the operation of system 100.

FIG. 9 illustrates the Future Realty System application implemented over a conventional computer system or network, according to the present invention. As shown, the presentation tier 810 may reside on several conventional computer systems, such as personal computers 910 and laptop computers 920, which may be communicatively coupled together by use of a local area network (e.g., Ethernet 930) and/or a wireless local area network.

Computer systems 910, 920 are conventional microprocessor based computers, including one or more input devices for allow a user to provide data to, and access data from, Future Realty System 200, such as a keyboard, mouse, touch pad, and the like, and a display device for displaying visual data to a user, such as a computer monitor, a flat panel display or other conventional display device which is suitable to display output generated by Future Realty System 200. The computer systems 910, 920 may also include one or more scanners 940, which may be used by participants (e.g., builders, developers or other providers) to scan future real estate agreements into the Future Realty System 200, and one or more printers 950, for printing records, notifications and reports from the Future Realty System 200. It should be appreciated that computer systems 910, 920 cooperatively permit a system user or operator to enter, modify, analyze and/or view data within Future Realty System 200, and to perform system maintenance, management and modification.

The computer systems 910, 920 will preferably include communications devices (e.g., modems, Ethernet cards, and the like) for transferring data over communications networks (e.g., the Internet 840). The communications devices allow the computer systems 910, 920 to remotely communicate with the Future Realty System 200 and Database 210.

The middleware tier 820 may reside on or more conventional server machines, such as an e-mail server 960 and a web-server 970, which may be adapted to receive and obtain information from external databases and networks (e.g., information from realty data sources 740), and database tier 830 may reside on a conventional database server 990. Servers 960, 970 and 990 may be communicatively coupled together by way of a network (e.g., Ethernet 980). The following table provides one non-limiting example of components that may be used to support the middleware tier 820 and database tier 830.

| Item | Specifications |
|---|---|
| Database Server 990 | Processor: Single Pentium IV 2.4 GHz |
| | Power Supply: Dual Hot Swapable power supplies |
| | Memory Size: 1 GB |
| | Disk Drives: 2 × 36 GB SCSI |
| | RAID Protection: RAID 1 |
| | VPN Interface: Included |
| Database | MS SQL Server ™ |
| Application Server | Macromedia ColdFusion ™ |
| for middleware tier | |
| 820 | |
| Server Operating | MS Windows 2000 ™ |
| System | |
| Web Server | Internet Information Server (IIS) ™ |
| Internet Access | DSL |
| Email Server | MS Exchange Server ™ |

As will be appreciated by those skilled in the art, different and/or additional hardware and software components may be selected based on the size, functions, and activity level of the Future Realty System 200.

D. Application Process Flow

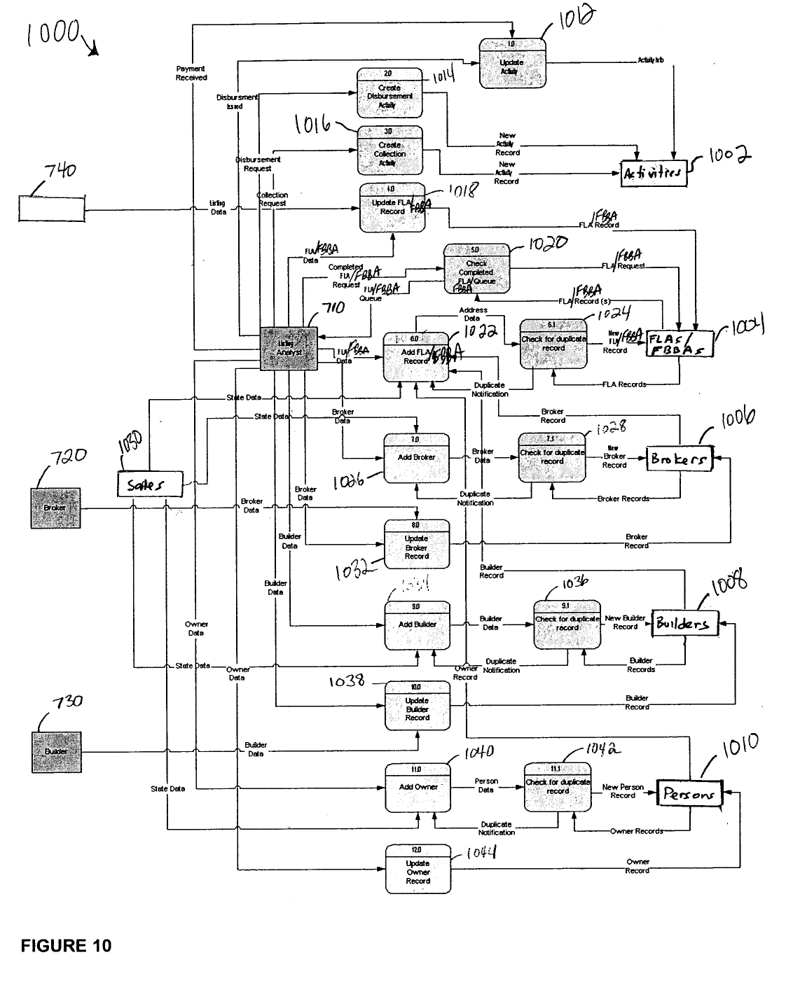

The following section provides a description of the data contained within the Future Realty System application and the manner in which this data flows through the application, according to one embodiment of the present invention. FIG. 10 illustrates a process flow diagram 1000 illustrating an exemplary operational flow of the application. In the example shown, the future real estate agreements comprise future listing agreements (FLAs) and/or future buyer/broker agreements (FBBAs), and the participants in the system include a builder, developer or other real estate service provider (Builder 730), one or more brokers or agents (Broker 720), and one or more prospective purchasers, who become owners (“Owner”) of property sold by the builder. Particularly, the Builder 730 procures the FLAs and/or FBBAs from the prospective purchasers in exchange for financial incentives. The Builder 730 then provides the FLAs and/or FBBAs to Brokers 720 in exchange for a portion of the commission received by the Brokers 720 when the properties are sold. In this example, a middleman may operate the system and provide listing analysts 710 who manage, monitor and update the system, as described below. Furthermore, in this example, the Future Realty System application utilizes the data elements and relationships shown in FIG. 11.

As shown in FIG. 10, the following processes may be performed by the Future Realty System application in the present example.

Adding FLA/FBBA Records

This process involves the adding Future Listing Agreements (FLA) and/or Future Buyer/Broker Agreements (FBBAs) records within the Future Realty System application. As new agreements are executed by Owners, the Listing Analysts 710 will receive copies of the FLAs, FBBAs or information describing the FLAs and/or FBBAs (e.g., from the builder) and add records into the Future Realty System application corresponding to the new agreements.

The FLA/FBBA information (FLA/FBBA Data) from the Listing Analyst 710, broker information (Broker Record) from the Brokers data store 1006, builder information (Builder Record) from the Builders data store 1008, owner information (Owner Record) from the Owners data store 1010 flows into the Add FLA/FBBA Record Process 1022 where it is used in the add FLA/FBBA process. The Process 1022 communicates the FLA/FBBA information (Address Data) to the Check for Duplicate Record Process 1024 where it is compared to existing FLA/FBBA records. This duplicate check process receives data flow (FLA/FBBA Records) from the FLAs/FBBAs data store 1004 in order to perform the comparison. If a record does not currently exist, the FLA/FBBA information (FLA/FBBA Record) then flows from Process 1022 into the FLAs/FBBAs data store 1004, where it is stored. If there is an existing record in the system, Process 1024 communicates a notification (Duplicate Notification) to Process 1022, and the process is terminated.

Review FLA/FBBA Queue

The application may include a Future Listing Agreements (FLA) and/or Future Buyer/Broker Agreements (FBBA) queue that stores FLAs/FBBAs that have been completed through a sale of property. This process involves reviewing the FLAs/FBBAs within the Future Realty System application. Once agreements are completed through sale of a property, they will be placed in the FLA/FBBA queue to be reviewed by the Listing Analysts 710. The listing analysts 710 may then ensure that all obligations for the FLAs/FBBAs have been satisfied.

The FLA/FBBA queue information (Completed Queue Request) flows from the Listing Analysts 710 into the Check Completed FLA/FBBA Queue Process 1020, where it is used to retrieve the completed FLA/FBBA records. The FLA/FBBA queue information (FLA/FBBA Request) then flows from Process 1020 into the FLAs/FBBAs data store 1004. Matching records are returned (FLA/FBBA Records) from the FLAs/FBBAs data store 1004 to Process 1020. The compiled queue (FLA/FBBA queue) then flows back out the Listing Analyst 710.

Updating FLA/FBBA Information

This process involves the updating FLA/FBBA information within the Future Realty System application from an external realty data source 740, such as an MLS or MRIS database. In the present embodiment, information from data source 740 (e.g., an MRIS database) is regularly and periodically imported to monitor which FLA/FBBA agreements have been completed.

The listing information (Listing Data) flows from the realty data source 740 into the Update FLA/FBBA Record Process 1018 where it is used to update the FLA/FBBA records in the event of a match. Additionally, listing data may also flow from the Listing Analysts 710, who may receive the data by other means, into Process 1018. The listing information (Listing Data) then flows from Process 1018 into the FLAs/FBBAs data store 1004. The listing information can then be compared to the existing records to determine if a match exists. If a match exists, the information may be added to the queue and provided to the Listing Analyst 710 to ensure that the appropriate parties are paid.

Tracking Receivables

This process involves the tracking of receivables originating from a completed transaction within the FLA/FBBA business process. When a home is sold for which the Future Realty System has a listing agreement, applicable fees need to be collected from the Broker.

The collection information (Collection Request) flows from the Listing Analyst 710 into the Create Collection Activity Process 1016 where it is used to create a collection activity. The activity information (New Activity Record) then flows from the Create Collection Activity Process 1016 into Activities data store 1002.

Tracking Disbursements

This process involves the tracking of disbursements originating from a completed transaction within the FLA/FBBA business process. When a home is sold for which Future Realty System 200 has a listing agreement and the applicable fees are collected from the Broker 710, the Builder 730 is then eligible for their compensation. The Listing Analyst 710 will create an activity to track this transaction.

The disbursement information (Disbursement Request) flows from the Listing Analyst 710 into the Create Disbursement Activity Process 1014 where it is used to create a disbursement activity. The activity information (New Activity Record) then flows from Process 1014 into the Activities data store 1002.

Receiving and Recording Funds

This process involves the receipt and recording of disbursement of funds resulting from a completed transaction within the FLA/FBBA business process. When a home is sold for which the Future Realty System has an FLA/FBBA, a collection request is sent to the Broker 720 for the previously agreed upon fee. Once the fees are collected, the Listing Analyst 710 will record the receipt of the fees by updating the collection activity created previously in “Tracking Receivables” Process. Subsequent to the collection of funds from the Broker 720, the system operator (e.g., middleman) will disburse referral fees to the Builder 730. The Listing Analyst 710 will record the disbursement of the fees to the Builder by updating the disbursement activity created previously in the “Tracking Disbursements” process.

The Listing Analyst 710 receives the payment receipt information (Payment Received) and communicates the information to the Update Activity Process 1012 where it is used to update the collection activity. The updated activity information (Activity Info) then flows from Process 1012 into the Activities data store 1002.

The Listing Analyst 710 receives the disbursement information (Disbursement Issued) and communicates the information to the Update Activity Process 1012 where it is used to update the disbursement activity. The updated activity information (Activity Info) then flows from Process 1012 into Activities data store 1002.

Adding Broker Records

This process involves adding Broker records within the Future Realty System application. As new brokers affiliate with and/or join the Future Realty System, the Listing Analysts 710 will add records into the Future Realty System application corresponding to the new brokers.

The broker information (Broker Data) from the Listing Analyst 710 and state information (State Data) from the States data store 1030 flows into the Add Broker Process 1026 where it is used in the add broker process. Process 1026 communicates the broker information (Broker Data) to the Check for Duplicate Record Process 1028, which compares the broker information to existing broker records. This duplicate check process receives data flow (Broker Records) from the Brokers data store 1006. If a record does not currently exist, the broker information (Broker Record) then flows from Process 1028 into the Brokers data store 1006, where it is stored. If there is an existing record in the system, Process 1028 communicates a notification (Duplicate Notification) to Process 1026, and the process is terminated.

Updating Broker Information

This process involves the updating Broker information within the Future Realty System application. From time to time, a Broker's contact information may need to be updated. In the present embodiment, the Listing Analysts 710 and/or Brokers 730 may perform these updates.

In this process, the broker information (Broker Data) flows from the Listing Analyst 710 or Broker 730 into the Update Broker Record Process 1032 where it is used to update the broker record. Particularly, the Process 1032 communicates the broker information (Broker Record) to the Brokers data store 1006 where it updates and/or replaces the broker's existing record.

Adding Builder Records

This process involves adding Broker records within the Future Realty System application. As new builders affiliate with and/or join the Future Realty System 200, the Listing Analysts 710 will add records into the Future Realty System application corresponding to the new builders.

The builder information (Builder Data) from the Listing Analyst 710 and state information (State Data) from the States data store 1030 flows into the Add Builder Process 1034 where it is used in the add broker process. Process 1034 communicates the builder information (Builder Data) to the Check for Duplicate Record Process 1036, which compares the broker information to existing builder records. This duplicate check process receives data flow (Builder Records) from the Builders data store 1008. If a record does not currently exist, the builder information (Builder Record) then flows from Process 1036 into the Builders data store 1008, where it is stored. If there is an existing record in the system, Process 1036 communicates a notification (Duplicate Notification) to the Add Builder Process 1034, and the process is terminated.

Updating Builder Information

This process involves the updating Builder information within the Future Realty System application. From time to time, a Builder's contact information may need to be updated. In the present embodiment, the Listing Analysts 710 and/or Builders 730 may perform these updates.

In this process, the builder information (Builder Data) flows from the Listing Analyst 710 or Builder 730 into the Update Builder Record Process 1038 where it is used to update the builder record. Particularly, the Process 1038 communicates the builder information (Builder Record) to the Builders data store 1008 where it updates and/or replaces the Builder's existing record.

Adding Owner Records

This process involves the adding Owner records within the Future Realty System application. As new owners affiliate with and/or join the Future Realty System (e.g., enter into an FLA/FBBA with a broker), the Listing Analysts 710 will add records into the Future Realty System application corresponding to the new owners.

The owner information (Owner Data) from the Listing Analyst 710 and state information (State Data) from the States data store 1030 flows into the Add Owner Process 1040 where it is used in the add owner process. The owner information (Person Data) then flows from Process 1040 into the Check for Duplicate Record Process 1042 where it is compared to existing owner records. This duplicate check process receives data flow (Person Records) from the Persons data store 1010. If a corresponding record does not currently exist in the Persons data store 1010, the owner information (Owner Record) then flows from the Process 1042 into the Persons data store 1010, where it is stored. If there is an existing record in the system, a notification (Duplicate Notification) flows from Process 1042 to the Add Owner Process 1040, and the process is terminated.

Updating Owner Information

This process involves the updating Owner information within the Future Realty System application. From time to time, owner contact information will need to be updated. In the present embodiment, the Listing Analysts 710 may perform these updates.

In this process, the owner information (Owner Data) flows from the Listing Analyst 710 into the Update Owner Record Process 1044 where it is used to update the owner record.

Particularly, the Process 1044 communicates the owner information (Owner Record) into the Persons data store 1010, where it updates and/or replaces the existing owner record.

On-line Help

The Future Realty System application may contain embedded an on-line help function to allow users, such as Listing Analysts 710, Brokers 720 and/or Builders 730 to become oriented with the application. The on-line help may contain an application overview section to walk the user through the typical functions of the application. The on-line help function may include an application documentation section to provide reference to all user types. Additionally, the on-line help function may contain a FAQ section to provide quick answers to common questions.

Accordingly, the present invention provides a method and system for creating and managing future real estate contracts. The method is preferably implemented by use of a computer system (e.g., the Future Realty System) that automatically and continuously monitors various realty data sources to detect proposed, pending and/or completed real estate transactions that trigger obligations under a future real estate agreement. Once an obligation has been triggered, the system may be used to notify the relevant parties and facilitate payment resulting from fulfilled obligations. The Future Realty Database provides a multidimensional, relational database that can be used to determine when an obligation under a future real estate agreement has become due, based on a variety of data.

While the foregoing has been with reference to particular embodiments of the invention, it will be appreciated by those skilled in the art that changes in these embodiments may be made without departing from the principles and spirit and scope of the invention, as set forth in the appended claims.

What is claimed is:

1) A system for managing future real estate agreements comprising:
a database for storing information regarding at least one future real estate agreements; and
at least one computer system that is communicatively coupled to the database and that is adapted to detect an event relating to an obligation under one the at least one future real estate agreements.

2) The system of claim 1 wherein the events comprise real estate transactions.

3) The system of claim 2 wherein at least one computer system is communicatively coupled to a realty data source which provides data regarding the real estate transactions.

4) The system of claim 3 wherein the at least one computer system is communicatively coupled to an MLS system which provides data regarding property listings.

5) The system of claim 1 wherein the future real estate agreements comprise future listing agreements.

6) The system of claim 1 wherein the future real estate agreements comprise agreements for representation in the purchase of a new home.

7) The system of claim 1 wherein the future real estate agreements comprise agreements for mortgage services.

8) The system of claim 1 wherein the future real estate agreements comprise agreements for title services.

9) The system of claim 1 wherein the future real estate agreements comprise agreements for home owner's insurance services.

10) The system of claim 1 wherein the at least one computer system is further adapted to generate electronic notifications to affected parties regarding obligations that have become due.

11) The system of claim 1 wherein the at least one computer system comprises an n-tier software platform that provides operational control of the system.

12) The system of claim 11 wherein the software platform comprises a presentation tier, a middleware tier and a database tier.

13) The system of claim 12 wherein the middleware tier is implemented on at least one server machine.

14) The system of claim 13 wherein the presentation tier is implemented on a client computer which is communicatively coupled to the at least one server machine through the Internet.

15) The system of claim 13 wherein the database tier is implemented on a database server which is communicatively coupled to the at least one server machine through a local area network.

16) The system of claim 1 wherein the at least one computer system comprises an input device that is adapted to receive information regarding the electronic records.

17) The system of claim 16 wherein the input device comprises a scanner.

18) The system of claim 1 wherein the at least one computer system comprises an output device that is adapted to display output information from the at least one computer system.

19) The system of claim 18 wherein the output device comprises a printer for printing notifications to affected parties regarding obligations that have become due.

20) The system of claim 1 wherein the database comprises a multidimensional relational database.

21) The system of claim 1 wherein the at least one computer system is further adapted to create the electronic records and store the created electronic records in the relational database.

22) A computerized method for managing future real estate agreements comprising:
creating an electronic records describing future real estate agreements;
storing the electronic records in a relational database; and
monitoring real estate transactions to detect when an obligation under a future real estate agreement has or may become due.

23) The computerized method of claim 22 further comprising:
notifying affected parties regarding obligations that have become due.

24) The computerized method of claim 23 further comprising:
facilitating payment to a participant resulting from a fulfilled obligation under a future real estate agreement.

25) The computerized method of claim 22 wherein monitoring real estate transactions comprises comparing data regarding the real estate transactions to the electronic records.

26) The computerized method of claim 25 wherein the data regarding the real estate transactions is obtained from an MLS system.

27) The computerized method of claim 25 wherein the data regarding the real estate transaction is obtained from an Internet database.

28) The computerized method of claim 25 wherein the data regarding the real estate transactions is obtained from a lien database.

29) The computerized method of claim 25 wherein the data regarding the real estate transactions is obtained from a real estate provider database.

30) A computer-readable medium having computer-executable instructions for performing a method for managing future real estate agreements, the method comprising:
creating an electronic record describing a future real estate agreement;
storing the electronic record in a relational database; and
monitoring real estate transactions to detect when an obligation under the future real estate agreement has or may become due.

31) The computer-readable medium of claim 30, wherein the method further comprises notifying affected parties regarding obligations that have become due.

32) The computer-readable medium of claim 31, wherein the method further comprises facilitating payment to a participant resulting from a fulfilled obligation under a future real estate agreement.

33) The computer-readable medium of claim 30, wherein the method further comprises monitoring real estate transactions comprises comparing data regarding the real estate transactions to the electronic records.

34) A method for creating and managing future real estate agreements comprising the steps of:
storing records of future real estate agreements; and
monitoring transactions to detect when an obligation under a future real estate agreement has or may become due.

35) The method of claim 34 further comprising the step of:
notifying affected parties of the obligations that have become due under the future real estate agreements.

36) The method of claim 35 further comprising the step of:
facilitating payment to a participant resulting from a fulfilled obligation under a future real estate agreement.

37) The method of claim 35 further comprising the step of:
creating a record of the future real estate agreement.

38) The method of claim 35 wherein the records are stored in a relational database.

39) The method of claim 38 wherein the step of monitoring real estate transactions includes comparing data describing the real estate transactions to the records stored in the relational database.

40) The method of claim 35 wherein the future real estate agreements comprise future listing agreements.

41) The method of claim 35 wherein the future real estate agreements comprise agreements for representation in the purchase of a new home.

42) The method of claim 35 wherein the future real estate agreements comprise agreements for mortgage services.

43) The method of claim 35 wherein the future real estate agreements comprise agreements for title services.

44) The system of claim 35 wherein the future real estate agreements comprise agreements for home owner's insurance services.

45) The method of claim 35 further comprising the step of:
providing a financial incentive to a party to enter into the future real estate agreement.

46) The method of claim 45 wherein the financial incentive comprises a reduction in closing costs relative to a purchase of real estate.

47) The method of claim 45 wherein the incentive is provided to the party by a builder.

48) The method of claim 45 wherein the incentive is provided to the party by a title company.

49) The method of claim 45 wherein the incentive comprises a reduction in costs relative to a mortgage.
